(19) United States
(12) Patent Application Publication
(10) Pub. No.: US 2013/0083251 A1
(43) Pub. Date: Apr. 4, 2013

(54) VIDEO PROJECTOR AND METHOD FOR DISPLAYING AN IMAGE

(71) Applicant: SANYO ELECTRIC CO., LTD., Osaka (JP)

(72) Inventor: Kazunori KOTANI, Nara-shi (JP)

(73) Assignee: SANYO ELECTRIC CO., LTD., Osaka (JP)

(21) Appl. No.: 13/627,682

(22) Filed: Sep. 26, 2012

(30) Foreign Application Priority Data
Sep. 30, 2011 (JP) 2011-218138
Aug. 31, 2012 (JP) 2012-191927

(51) Int. Cl. H04N 5/44

(52) U.S. Cl. 348/734; 348/E05.096

(57) ABSTRACT

A video projector is provided with a projector body configured to project light to display an image and including a signal receiver and a memory which stores data. A remote controller is configured to control the projector body from a distance and includes a storage medium connector, to which an information storage medium is connectable in a removable manner, and a signal transmitter, which transmits a signal receivable by the signal receiver through wireless communication. The remote controller transmits the data stored in the information storage medium, which is connected to the storage medium connector, from the signal transmitter through wireless communication. The projector body stores the data received with the signal receiver in the memory and displays an image based on the data stored in the memory after the signal receiver completes receiving the data from the signal transmitter.

### CROSS-REFERENCE TO RELATED APPLICATIONS

This application is based upon and claims the benefit of priority from prior Japanese Patent Applications No. 2011-218138, filed on Sep. 30, 2011, and No. 2012-191927, filed on Aug. 31, 2012, the entire contents of which are incorporated herein by reference.

### BACKGROUND

The present invention relates to a video projector and a method for displaying an image.

A known video projector, such as an LCD projector, includes a remote controller that controls the operation of the projector from a distance. A typical remote controller transmits signals that activate or deactivate the projector or signals that set the operation of the projector.

Japanese Laid-Open Patent Publication No. 2006-292997 describes a video projector that includes a projector body provided with a storage medium connector. An information storage medium is connected in a removable manner to the storage medium connector. The projector body displays images based on the data stored in the information storage medium.

In the above publication, the storage connector is a USB terminal. In this configuration, to display images based on the data stored in the information storage medium, a USB memory is required to be connected to the USB terminal of the projector body.

Japanese Laid-Open Patent Publication No. 2010-226483 describes another video projector. In this video projector, a remote controller includes a USB port and a wireless communication unit. A USB memory is connected to the USB port. The wireless communication unit transmits the data read from the USB memory to the projector body through wireless communication. This video projector does not store the data that is transmitted to the projector body through wireless communication and directly performs image signal processing on the data to display an image.

A projector body may be used in a state arranged at a high location, such as a ceiling, where the projector body cannot be reached by a user. When the projector body of Japanese Laid-Open Patent Publication No. 2006-292997 is arranged at such a location that cannot be reached by the use, the information storage medium cannot be connected to the storage medium connector. In such a case, images cannot be displayed based on the data stored in the information storage medium.

In the video projector of Japanese Laid-Open Patent Publication No. 2010-226483, image data is required to be transmitted through wireless communication from the remote controller whenever displaying an image based on the data stored in the USB memory. Further, with this video projector, image data is required to be continuously transmitted when displaying a moving image. Accordingly, in this video projector, data transmission is required whenever an image is displayed, and the transmission of moving image data lengthens the wireless communication time. This increases the amount of power consumption and drains the battery of the remote controller within a short period of time.

### SUMMARY

One aspect of the present invention is a video projector including a projector body that is configured to project light to display an image and including a signal receiver and a memory which stores data. A remote controller is configured to control the projector body from a distance and includes a storage medium connector, to which an information storage medium is connectable in a removable manner, and a signal transmitter, which transmits a signal receivable by the signal receiver through wireless communication. The remote controller transmits the data stored in the information storage medium, which is connected to the storage medium connector, from the signal transmitter through wireless communication. The projector body stores the data received with the signal receiver in the memory and displays an image based on the data stored in the memory after the signal receiver completes receiving the data from the signal transmitter.

A further aspect of the present invention is a method for displaying an image using a projector body, which projects light to display the image, and a remote controller, which controls the projector body from a distance. The remote controller includes a storage medium connector, to which an information storage medium is connectable in a removable manner, and a signal transmitter, which transmits a signal receivable by the signal receiver through wireless communication, and the projector body includes a signal receiver, which receives the signal transmitted from the signal transmitter, and a memory, which stores data. The method includes transmitting the data stored in the information storage medium, which is connected to the storage medium connector, from the signal transmitter through wireless communication, storing the data received with the signal receiver in the memory, and displaying an image based on the data stored in the memory after the signal receiver completes receiving the data from the signal transmitter.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a projector body and remote controller in a video projector according to a first embodiment;

FIG. 2 is a plan view illustrating the remote controller of FIG. 1;

FIG. 3 is a schematic block diagram of the projector body illustrated in FIG. 1;

FIG. 4 is a schematic block diagram of the remote controller illustrated in FIG. 1;

FIG. 5A is an operation flowchart of the remote controller illustrated in FIG. 1;

FIG. 5B is an operation flowchart of the projector body illustrated in FIG. 1;

FIG. 6 is a schematic diagram of a file upload menu displayed by the projector body of FIG. 1;

FIG. 7 is a schematic diagram of a file delete menu displayed by the projector body;

FIG. 8 is a block diagram of a second embodiment of the remote controller illustrated in FIG. 1;

FIG. 9 is a schematic diagram illustrating an operation screen on the remote controller of FIG. 8;

FIG. 10A is an operation flowchart of the remote controller illustrated in FIG. 8;

FIG. 10B is an operation flowchart of a projector body in a video projector including the remote controller illustrated in FIG. 8;

FIG. 11 is a schematic diagram of a file upload menu illustrated on the remote controller of FIG. 8;

FIG. 12 is a schematic diagram illustrating an operation menu on a third embodiment of the remote controller of FIG. 8;

FIG. 13 is a schematic diagram of a file display menu illustrated on the remote controller of FIG. 12;

FIG. 14 is a schematic diagram of a file delete menu illustrated on the remote controller of FIG. 12; and

FIG. 15 is a schematic diagram of a modification of the remote controller illustrated in FIG. 1.

### DESCRIPTION OF THE EMBODIMENTS

A video projector 1 of a first embodiment will now be described with reference to the drawings.

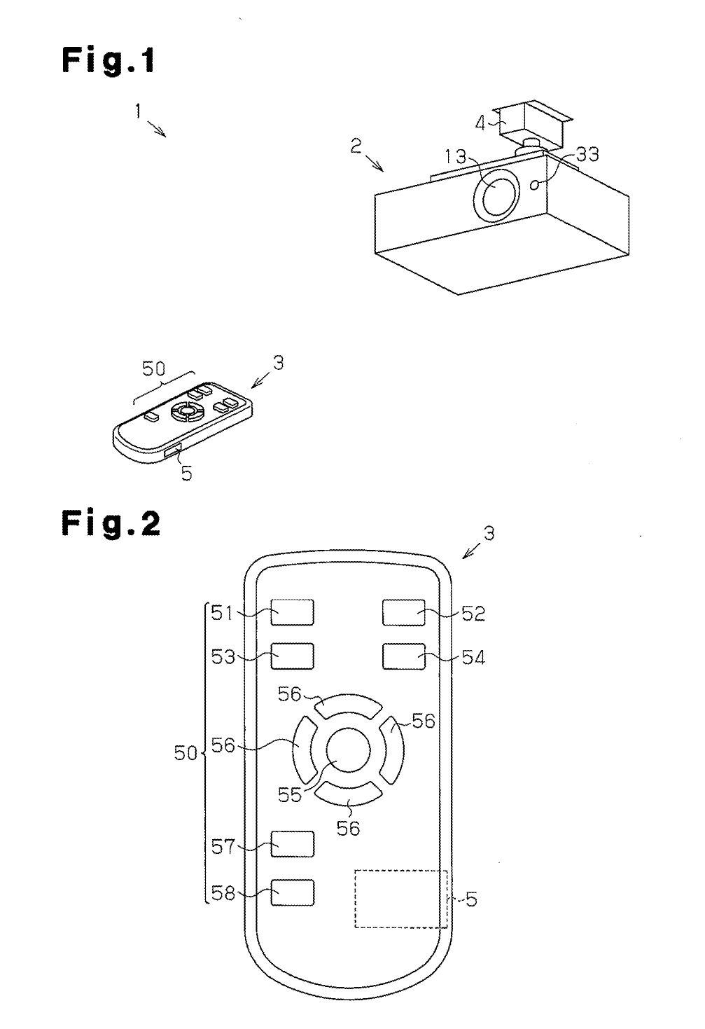

As illustrated in FIG. 1, the video projector 1 includes a projector body 2 and a remote controller 3, which controls the operation of the projector body 2 from a distance. A ceiling hanger 4, which is attached to a ceiling (not illustrated), suspends the projector body 2 from the ceiling. The remote controller 3 is dedicated for the projector body 2.

The projector body 2 includes a projection lens 13, which projects light. The projector body 2 projects light of an image from the projection lens 13 to display the image on an imaging surface (not illustrated), such as a screen or wall, in front of the projector body 2.

The projector body 2 includes an infrared receiver 33, which is used when operating the projector body 2 with the remote controller 3. The infrared receiver 33 receives remote control signals transmitted through wireless communication from outside the projector body 2.

A memory card 5 is attached to the remote controller 3. The memory card 5 is a removable medium and may be a nonvolatile readable memory. Further, the memory card 5 is an information storage medium that does not include a drive unit. The memory card 5 stores image-related data, such as bit map files, PNG files, and GIF files.

The remote controller 3 has an operation unit 50 including a plurality of push button switches. When the operation unit 50 is operated, for example, when a push button switch is pushed, the remote controller 3 transmits a remote control signal that is in accordance with the pushed switch.

Referring to FIG. 2, the operation unit 50 includes a power button switch 51, a standby button switch 52, a menu button switch 53, a cancel button switch 54, an item select button switch 55, pointer movement button switches 56, an upload button switch 57, and a delete switch 58.

Each of switches 51 to 58 is a push button switch that functions to form a man-machine interface. Each push button switch includes a corresponding push button, which is illustrated in FIG. 2 and functioning as an interface, and a switch (not illustrated), which is arranged on a circuit substrate. To facilitate the description hereafter, the power button switch 51 will be referred to as the switch 51, the standby button switch 52 will be referred to as the switch 52, the menu button switch 53 will be referred to as the switch 53, the cancel button switch 54 will be referred to as the switch 54, the item select button switch 55 will be referred to as the switch 55, the pointer movement button switches 56 will be referred to as the switches 56, the upload button switch 57 will be referred to as the switch 57, and the delete switch 58 will be referred to as the switch 58.

An operation that is to be performed by the projector body 2 is assigned to each of the switches 51 to 58. When the switch 51 is operated, the projector body 2, which is not displaying an image, starts an image displaying operation. When the switch 52 is operated, the projector body 2, which is displaying an image, stops an image displaying operation. When the switch 53 is operated, the projector body 2, which is displaying an image, displays a menu image. The menu image includes a list of functions, which can be implemented by the projector body 2, and a pointer, which is pointed to any one of the items shown in the list. The switch 54 is used to cancel the operation of the operation unit 50.

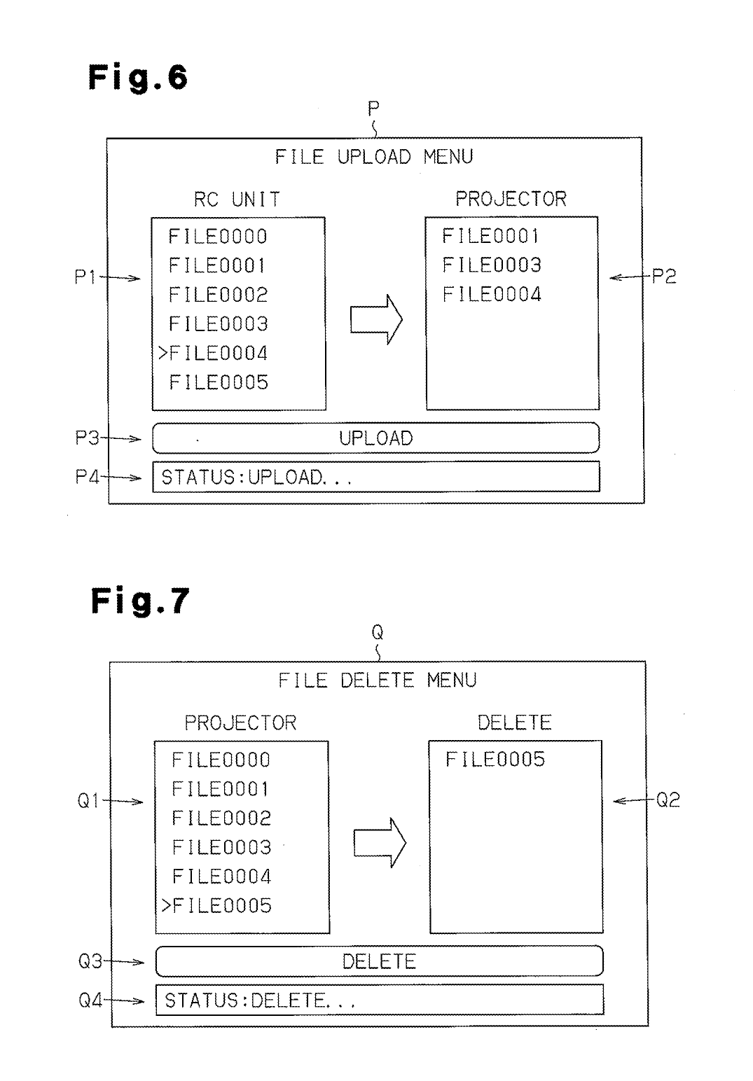

The switch 55 is used to select the item pointed by the pointer in the menu image. The switches 56 are used to move the pointer in the menu image. The switch 57 is used to display a file upload menu P (refer to FIG. 6) with the projector body 2. The switch 58 is used to display a file delete menu Q (refer to FIG. 7) with the projector body 2.

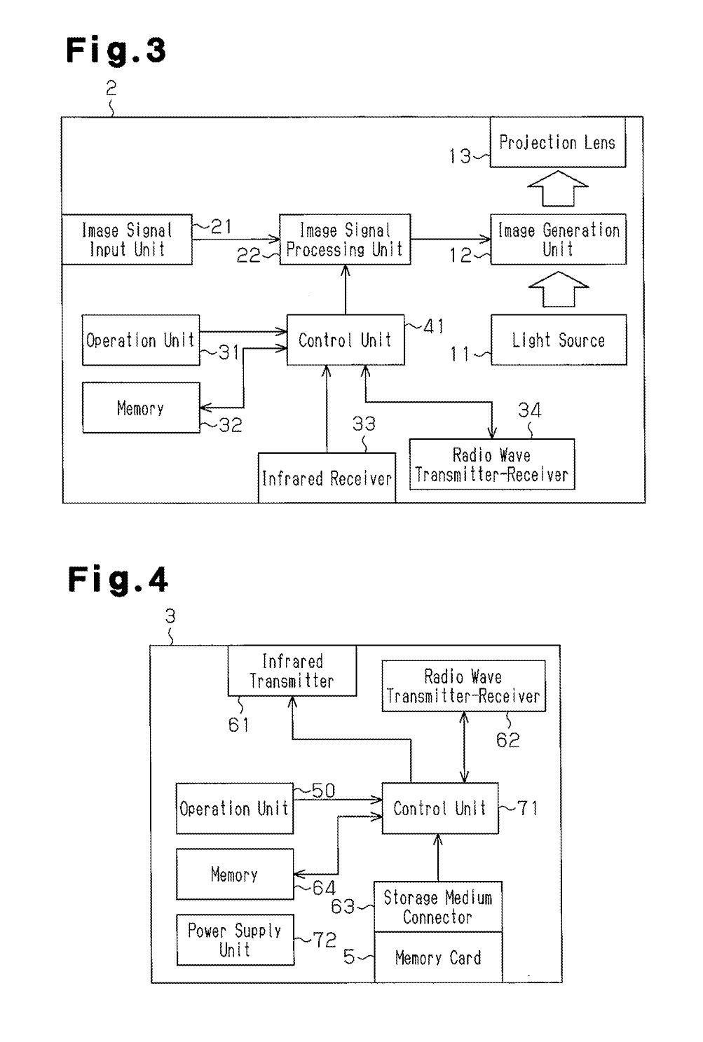

The configuration of the projector body 2 will now be described with reference to FIG. 3.

The projector body 2 includes optical components for displaying images. The optical components includes a light source 11, an image generation unit 12, which is formed by an electro-optical device, and the projection lens 13. Further, the optical components include, for example, an integrator lens (not illustrated) and the like.

The light source 11 is formed by, for example, a discharge lamp, such as an ultra-high pressure mercury lamp or a metal halide lamp. The image generation unit 12 includes, for example, dot matrix type liquid crystal light valves. The projection lens 13 includes a group of combined lenses. The light emitted from the light source 11 and transmitted through the liquid crystal light valves (image generation unit) is projected by the projection lens 13 and displayed as an enlarged image.

The projector body 2 includes an image signal input unit 21 and an image signal processing unit 22. The image signal input unit 21 receives an image signal from outside the projector body 2. The image signal processing unit 22 performs a predetermined signal process on an image signal.

The image signal input unit 21 includes an image signal input terminal and a wireless module. An image signal cable (not illustrated), for example, can be connected to the image signal input terminal. The wireless module receives image signals transmitted on radio waves. The image signal processing unit 22 includes a signal processing circuit that performs various types of signal processes, such as an on-screen display (OSD) process or a scaling process, on the image signals that are sent to the image generation unit 12.

The image generation unit 12 drives the Liquid crystal light valves based on the image signals from the image signal processing unit 22. The light from the light source 11 that enters the liquid crystal light valves is transmitted through the light valves to generate an image based on the image signal.

Further, the projector body 2 includes an operation unit 31, a memory 32, an infrared receiver 33, and a radio wave transmitter-receiver 34. The operation unit 31 operates the projector body 2. The memory 32 is formed by a nonvolatile memory and stores information. The infrared receiver 33 receives infrared signals. The radio wave transmitter-receiver 34 transmits and receives radio wave signals.

The operation unit 31 includes, for example, a man- machine interface formed by, for example, push buttons, dials, or a touch panel. A user may operate the projector body 2 with the operation unit 31 instead of using the remote controller 3. In other words, the operation unit 31 may be used as an alternative to the operation unit 50 of the remote controller 3.

The infrared receiver 33 is formed by an infrared light reception module that includes a photodiode. The infrared receiver 33 receives signals from the remote controller 3. The projector body 2 is operated by remote control codes included in the signals received by the infrared receiver 33.

The radio wave transmitter-receiver 34 is formed by a wireless module including an antenna. The radio wave transmitter-receiver 34 is one example of a signal receiver that receives wireless signals transmitted on radio waves from the remote controller 3.

The projector body 2 further includes a control unit 41 that controls each part of the projector body 2, such as the light source 11 and the image signal processing unit 22.

The control unit 41 is configured by one or more integrated circuits. The control unit 41 controls the operation of the projector body 2 based on operation programs stored in the memory 32.

The configuration of the remote controller 3 will now be described with reference to FIG. 4.

The remote controller 3 includes an infrared transmitter 61, a radio wave transmitter-receiver 62, a storage medium connector 63, and a memory 64. The infrared transmitter 61 transmits infrared signals. The radio wave transmitter-receiver 62 transmits and receives radio wave signals. The memory card 5 is connectable in a removable manner to the storage medium connector 63. The memory 64 is formed by a non-volatile memory and stores information.

The infrared transmitter 61 is formed by an infrared light emitting module, which includes a light emitting diode. The infrared transmitter 61 transmits signals including remote control codes that are in accordance with the operation of the operation unit 50 to the projector body 2.

The radio wave transmitter-receiver 62 is formed by a wireless module including an antenna. The radio wave transmitter-receiver 62 is one example of a signal transmitter that transmits, on radio waves, wireless signals that can be received by the radio wave transmitter-receiver 34 of the projector body 2.

The storage medium connector 63 is formed by, for example, a card connector that can be connected to the memory card 5. The memory card 5 is a portable medium.

Further, the remote controller 3 includes a control unit 71 and a power supply unit 72. The control unit 71 controls each part of the remote controller 3, such as the infrared transmitter 61 and the radio wave transmitter-receiver 62. The power supply unit 72 supplies power to each part of the remote controller 3.

The control unit 71 is formed by one or more integrated circuits. The control unit 71 controls the operation of the remote controller 3 based on operation programs stored in the memory 64. The power supply unit 72 is formed by, for example, a chemical cell such as a dry battery.

The functions of the projector body 2 and the remote controller 3 will now be described.

In addition to a function for receiving signals from the radio wave transmitter-receiver 62 with the radio wave transmitter-receiver 34, the projector body 2 has a received data storage function, a display data selection function, a stored data display function, a delete data selection function, and a data deletion function.

The received data storage function stores the data received by the radio wave transmitter-receiver 34 in the memory 32. In this example, the control unit 41 stores data, which is included in the signals received by the radio wave transmitter-receiver 34, as information in the memory 32.

The display data selection function determines, from the data stored in the memory 32, the display data that is to be used as an image. In this example, the control unit 41 determines the display data based on the operation of the switches 55, 56, and 57 in the operation unit 50, which form a display data selection operation unit.

The stored data display function displays an image based on the data stored in the memory 32 after the radio wave transmitter-receiver 34 completes the reception of signals including data. In this example, the control unit 41 controls the image signal processing unit 22 to provide the image generation unit 12 with images signals based on the data stored in the memory 32. When the display data is determined with the display data selection function, an image is displayed based on the display data selected by the user who uses the display data selection operation unit.

The delete data selection function determines the data that is to be deleted from the memory 32. In this example, the control unit 41 determines the data to be deleted based on the operation of the switches 55, 56, and 58 in the operation unit 50, which form a delete data selection operation unit.

The data deletion function deletes the data stored in the memory 32. In this example, the control unit 41 deletes data, which was received by the radio wave transmitter-receiver 34, from the memory 32. When the data to be deleted is determined by the delete data selection function, the data selected by the user with the delete data selection operation unit is deleted from the memory 32.

Further, the projector body 2 includes an on-screen display (OSD) function that displays an image, namely, an OSD image, that differs from the image based on the image signals input to the image signal input unit 21. In the present example, the control unit 41 controls the image signal processing unit 22, which performs an OSD process, to provide the image generation unit 12 with an image signal of an OSD image.

The remote controller 3 has a transmission data selection function and a data transmission function.

The transmission data selection function determines, from the data stored in the memory card 5 connected to the storage medium connector 63, the data transmitted through wireless communication from the radio wave transmitter-receiver 62. In this example, the control unit 71 determines the transmission data based on the operation of the switches 55 and 56 in the operation unit 50, which form a transmission data selection operation unit.

The data transmission function transmits the data stored in the memory card 5 connected to the storage medium connector 63 through wireless communication from the radio wave transmitter-receiver 62. In this example, the control unit 71 reads the data stored in the memory card 5 and transmits signals including the data from the radio wave transmitter-receiver 62. When the transmission data is determined by the transmission data selection function, the transmission data selected by the user with the transmission data selection operation unit is transmitted through wireless communication from the radio wave transmitter-receiver 62.

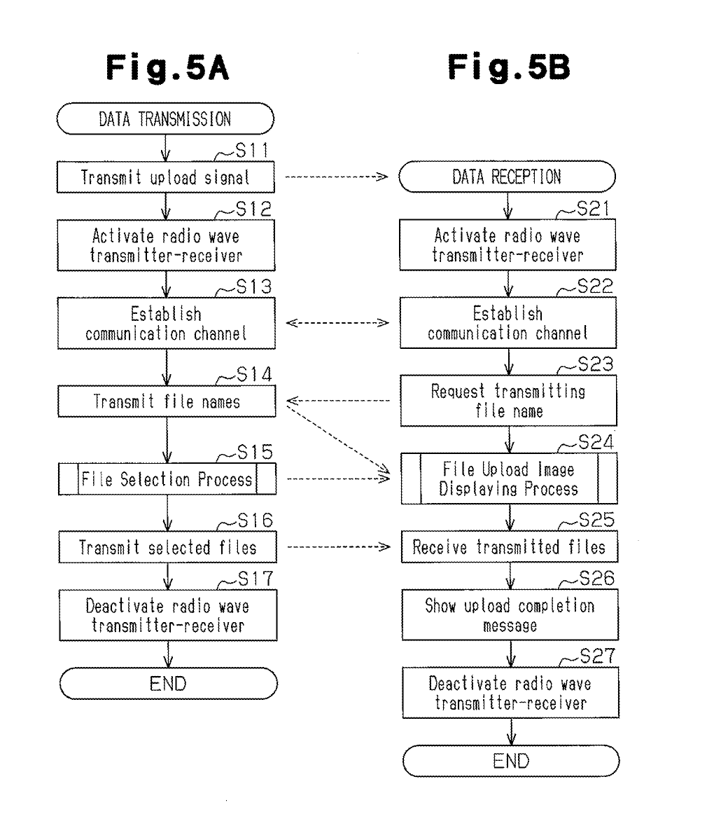

Data transmission performed by the remote controller 3 will now be described with reference to FIG. 5A. The data transmission starts when the user pushes the switch 57 of the operation unit 50.

The control unit 71 generates a remote control code in accordance with the operation of the switch 57. Further, the control unit 71 transmits upload signals, which include the remote control codes, from the infrared transmitter 61 (step S11).

Then, the control unit 71 supplies power from the power supply unit 72 to the radio wave transmitter-receiver 62 and activates the radio wave transmitter-receiver 62 (step S12). The activated radio wave transmitter-receiver 62 establishes a communication channel with the radio wave transmitter-receiver 34, which is activated in the projector body 2 (step S13).

After the communication channel is established, the radio wave transmitter-receiver 62 receives a file name request signal from the projector body 2. Based on the file name request signal, the control unit 71 reads the data stored in the memory card 5 and transmits the file names of the data stored in the memory card 5 from the radio wave transmitter-receiver 62 (step S14). This displays the file upload menu P such as that illustrated in FIG. 6. The file upload menu P includes an image P1 of a list of file names stored in the memory card 5, that is, a list of the data stored in the memory card 5. The file upload menu P also includes an image P2 of a list of file names to be transmitted, that is, a list of the data selected as the transmission data. Further, the file upload menu P includes an image P3 of an upload key used to transmit the selected data and an image P4 indicating a transmission status of the selected data.

Then, the control unit 71 performs a file selection process to select the files transmitted to the projector body 2 (step S15). In the file selection process of step S15, the control unit 71 determines the data transmitted to the projector body 2 based on the operation of the operation unit 50 by the user.

The file selection process will now be described. The user moves the pointer downward or upward with the switches 56 in the image P1 of the list of the data stored in the memory card 5 to select a file that the user wishes to transmit. Then, the user pushes the switch 55. This adds the name of the file that is to be transmitted in the list of the image P2.

After the selection of the transmission data is completed in step S15, the user moves the pointer downward with the switch 56 to select the image P3 of the upload key. Then, the user pushes the switch 55. This highlights the peripheral line of the image P3. Then, the control unit 71 transmits the files selected in step S15, that is, the data of the files shown in the image P2, from the radio wave transmitter-receiver 62 to the projector body 2 (step S16). The image P4 shows the message of “UPLOAD” during the file transmission and changes the message to “COMPLETE” when the file transmission is completed.

After the file transmission is completed, that is, after data transmission is completed, the control unit 71 stops supplying power from the power supply unit 72 to the radio wave transmitter-receiver 62 and deactivates the radio wave transmitter-receiver 62 (step S17). This reduces power consumption.

In any one of steps S11 to S16, when the switch 54 of the operation unit 50 is pushed, the control unit 71 deactivates the radio wave transmitter-receiver 62 and ends the data transmission from the remote controller 3. The control unit 71 also deactivates the radio wave transmitter-receiver 62 to end the data transmission from the remote controller 3 when a communication channel cannot be established in step S13 and when an established channel cannot be maintained.

Data reception performed by the projector body 2 will now be described with reference to FIG. 5B. The data reception starts when the infrared receiver 33 receives an upload signal.

When an upload signal is received, the control unit 41 supplies the radio wave transmitter-receiver 34 with power from an external power supply (not illustrated), which is arranged outside the projector body 2, to activate the radio wave transmitter-receiver 34 (step S21). The activated radio wave transmitter-receiver 34 establishes a communication channel with the radio wave transmitter-receiver 62 activated in the remote controller 3 (step S22).

After the radio wave transmitter-receiver 62 establishes a file name communication channel of the data stored in the memory card 5, the control unit 41 sends a file name request signal to the radio wave transmitter-receiver 34 and requests the remote controller 3 to transmit the file names of the data stored in the memory card 5 (step S23).

Then, the control unit 41 performs a file upload image displaying process to display the file upload menu (step S24). In the file upload image displaying process, the control unit 41 controls the image signal processing unit 22, which performs an OSD process, to provide image signals of an OSD image to the image generation unit 12. The content of the OSD image is the file upload menu P illustrated in FIG. 6 and updated whenever the operation unit 50 is operated.

Next, after the user completes the selection of the transmission data in step S15, the control unit 41 receives the data transmitted from the radio wave transmitter-receiver 62 of the remote controller 3 in step S16 with the radio wave transmitter-receiver 34 (step S25). Further, the control unit 41 stores the data received by the radio wave transmitter-receiver 34 in the memory 32.

After the file transmission is completed, that is, after data reception is completed, the control unit 41 shows an upload completion message that indicates the completion of the file transmission (step S26). That is, the control unit 41 shows an image including the upload completion message as an OSD image.

Then, the control unit 41 stops supplying power from the external power supply to the radio wave transmitter-receiver 34 and deactivates the radio wave transmitter-receiver 34 (step S27). This reduces power consumption. The control unit 41 also deactivates the radio wave transmitter-receiver 34 to end the data reception with the projector body 2 when a communication channel cannot be established in step S22 and when an established channel cannot be maintained.

In this manner, when the remote controller 3 transmits files to the projector body 2, the file upload menu P is displayed by the projector body 2. This allows the user of the remote controller 3 to refer to the file upload menu P and check the data stored in the memory card 5, the selected transmission data, and the transmission status of the data transmitted from the remote controller 3.

When the projector body 2 displays the data stored in the memory 32, the projector 2 displays a file display menu (not illustrated) as an OSD image.

The file display menu is an image of a list of the file names stored in the memory 32 or a thumbnail of the files stored in the memory 32. That is, the file display menu is an image of a list of the data stored in the memory 32.

The display of the file display menu by the projector body 2 allows the user to select data from the displayed data that is stored in the memory 32 by referring to the file display menu.

Further, when the switch 58 of the remote controller 3 is operated, the projector body 2 displays the file delete menu Q, which is illustrated in FIG. 7, as an OSD image. The file delete menu Q is used to delete data from the memory 32.

The file delete menu Q includes an image Q1 of a list of the data stored in the memory 32, that is, a list of the file names of the stored data. The file delete menu Q also includes an image Q2 of a list of the file names of the data that is to be deleted, that is, a list of the data selected as deletion data. Further, the file delete menu Q includes an image Q3 of a delete key used to delete the selected files and an image Q4 indicating a data deletion status of the projector body 2.

The file deletion process will now be described. In the image Q1 showing the list of the file names stored in the memory 32, the user moves the pointer upward and downward with the switches 56 and then pushes the switch 55 to select the file that the user wishes to delete. This shows the file name of the data that is to be deleted in the image Q2.

After all of the files that the user wishes to delete are shown in the image Q2, the user moves the pointer downward with the switches 56 and selects the image Q3 of the delete key. When the user pushes the switch 55, the peripheral line of the image Q3 is highlighted, and the files that are to be deleted are deleted. The image Q4 shows the message of “DELETE” during the file deletion and changes the message to “COMPLETE” when the file deletion is completed.

In this manner, in the first embodiment, the projector body 2 displays the file delete menu Q. This allows the user to refer to the file delete menu Q and check the data stored in the memory 32, the selected deletion data, and the status of the data deletion in the projector body 2.

The operation of the video projector 1 will now be described.

The video projector 1 determines the transmission data that is to be transmitted to the projector body 2 from the data stored in the memory card 5 with the transmission data selection function of the remote controller 3. Then, the video projector 1 transmits the data stored in the memory card 5 from the remote controller 3 to the projector body 2 with the data transmission function of the remote controller 3. The projector body 2 receives the data transmitted from the remote controller 3 to the projector body 2, that is, the data uploaded from the memory card 5. The video projector 1 stores the data uploaded to the projector body 2 in the memory 32 with the received data storage function of the projector body 2.

The video projector 1 determines the display data that is to be displayed as an image from the data stored in the memory 32 with the display data selection function of the projector body 2. Then, the video projector 1 displays the data stored in the memory 32, that is, an image of the data stored in the memory card 5, with the stored data display function of the projector body 2. Further, the video projector 1 determines the deletion data that is to be deleted from the memory 32 with the deletion data selection function of the projector body 2. The video projector 1 deletes the selected deletion data from the memory 32 with the data deletion function of the projector body 2.

The video projector 1 of the first embodiment has the advantages described below.

(1) The remote controller 3 includes the storage medium connector 63 and the radio wave transmitter-receiver 62, which serves as a signal transmitter. The projector body 2 includes the radio wave transmitter-receiver 34, which serves as a signal receiver, and the memory 32. The remote controller 3 has the data transmission function, and the projector body 2 has the received data storage function and the stored data display function. In this configuration, the projector body 2 receives the data stored in the memory card 5, which is connected to the storage medium connector 63 of the remote controller 3, through wireless communication from the radio wave transmitter-receiver 62 of the remote controller 3 and displays an image based on the data received with the radio wave transmitter-receiver 34. Accordingly, even when the projector body 2 is arranged at a location where it cannot be reached by the user, an image can be displayed based on the data stored in the memory card 5.

(2) The projector body 2 stores the data received with the radio wave transmitter-receiver 34 in the memory 32 and displays an image based on the data stored in the memory 32 after the radio wave transmitter-receiver 34 completes receiving data. Thus, the remote controller 3 does not have to continuously transmit data through wireless communication when the projector body 2 displays an image. Accordingly, in comparison with a configuration in which the remote controller 3 continuously transmits data when the projector body 2 displays an image, the wireless communication time can be shortened, and the power consumption of the remote controller 3 can be reduced. Thus, the cycle for exchanging the battery of the remote controller 3 can be lengthened.

(3) The memory card 5, which serves as an information storage medium, is connected to the storage medium connector 63 of the remote controller 3, and the radio wave transmitter-receiver 62 transmits data on radio waves. Thus, in comparison to a configuration that uses a removable hard disk as an information storage medium, the information storage medium and the storage medium connector 63 can be miniaturized. Further, the radio wave transmitter-receiver 62 of the remote controller 3 transmits data on radio waves. Thus, in comparison to a structure that transmits data with infrared light, the data transmission range is enlarged.

(4) The remote controller 3 includes the operation unit 50, which serves as the transmission data selection operation unit and configures a man-machine interface. Further, the remote controller 3 has the transmission data selection function that determines the transmission data based on the operation of the operation unit 50 by the user. Accordingly, the transmission data transmitted through wireless communication from the radio wave transmitter-receiver 62 is determined through the operation of the operation unit 50. Thus, the user can select the data transmitted through wireless communication from the radio wave transmitter-receiver 62 of the remote controller 3.

(5) The remote controller 3 includes the operation unit 50, which serves as the delete data selection operation unit and configures a man-machine interface. Further, the remote controller 3 has the delete data selection function that determines the data to be deleted based on the operation of the operation unit 50 by the user. Accordingly, the data that is deleted from the memory 32 of the projector body 2 is determined through the operation of the operation unit 50. Thus, the user can select the data to be deleted from the memory 32 of the projector body 2.

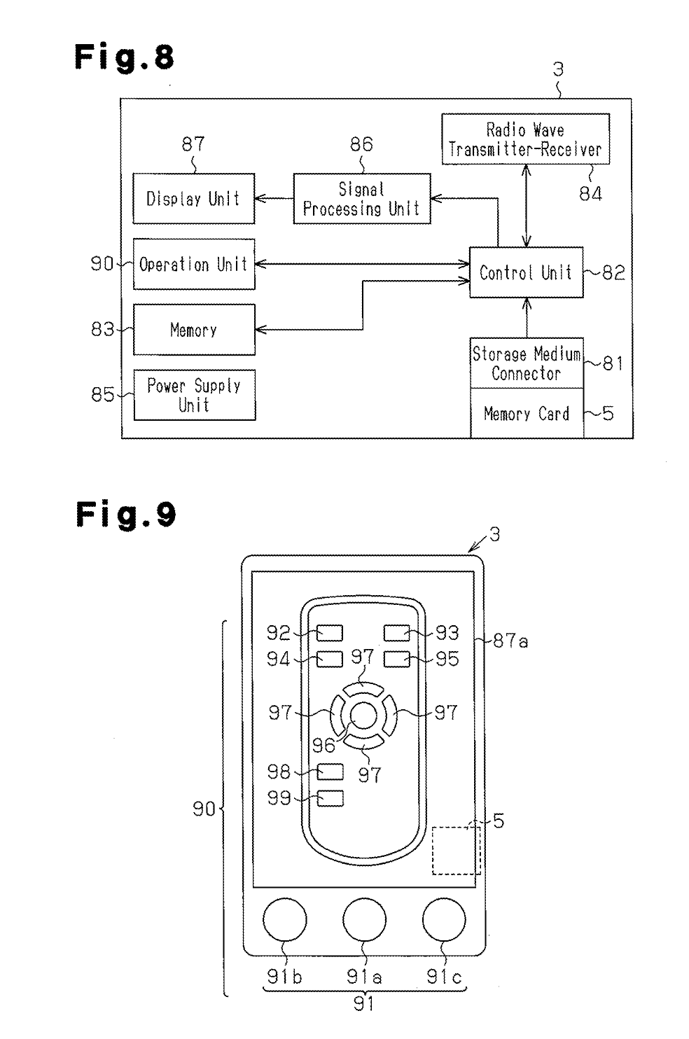

A video projector 1 of a second embodiment will now be described with reference to FIGS. 8 to 11. Like or same reference numerals are given to those components that are the same as the corresponding components of the first embodiment. Such components will not be described in detail.

As described above, the video projector 1 of the first embodiment uses the dedicated remote controller 3 to operate the projector body 2 through infrared communication and transmit the image data stored in the memory card 5 to the projector body 2 through wireless communication.

In contrast, the video projector 1 of the second embodiment uses a smartphone (refer to FIG. 8) as the remote controller 3 to transmit the image data stored in the memory card 5 and operate the projector body 2 through wireless communication. In this case, a remote control application that controls the operation of the projector body 2 from a distance is installed in a general-purpose smartphone. The video projector 1 of the second embodiment is convenient in that the data stored in the memory card 5 does not have to be transmitted and in that the projector body 2 can also be operated by a typical conventional remote controller that uses infrared light.

To be precise, the remote controller 3 of the second embodiment refers to a combination of a smartphone and a typical remote controller of the conventional art. However, in the description of the second embodiment, a smartphone will be used as the remote controller. Accordingly, in the description of the second embodiment, the remote controller will refer to a smartphone including a remote control application. Further, the typical remote controller of the conventional art is one that is required to transmit signals for activating and deactivating the power supply of the projector body 2 and signals for setting the operation of the projector body 2. Such a typical remote controller will not be described below in detail.

The projector body 2 of the second embodiment has the same configuration (refer to FIG. 3) as that of the first embodiment. More specifically, the projector 2 of the second embodiment includes the operation unit 31, the memory 32, the infrared receiver 33, the radio wave transmitter-receiver 34, and the control unit 41.

The operation unit 31 may have the same configuration as that of the first embodiment and can operate the projector body 2 without the remote controller 3.

The memory 32 may have the same configuration as that of the first embodiment and store programs for controlling the operation of the projector body 2 and data included in signals received by the radio wave transmitter-receiver 34.

The infrared receiver 33 may have the same configuration as that of the first embodiment and is applicable to the typical prior art remote controller that is dedicated to the projector body 2.

The radio wave transmitter-receiver 34 may have the same configuration as that of the first embodiment and include a signal receiver that receives wireless signals transmitted on radio waves. That is, the radio wave transmitter-receiver 34 receives operation signals transmitted from the smartphone that serves as the remote controller 3 in addition to signals related to images stored in the memory card 5.

In the first embodiment, the control unit 41 controls the operation of the projector body 2 based on operation programs stored in the memory 32. The operation programs may be provided from the remote controller 3 and stored in the memory 32. More specifically, the control unit 41 of the second embodiment may drive the projector body 2 based on operation commands transmitted from the smartphone that serves as the remote controller 3. Further, the control unit 41 stores the data related to images stored in the memory card 5 and transmitted from the smartphone, which serves as the remote controller 3, in the memory 32.

The smartphone that serves as the remote controller 3 will now be described in detail. The smartphone will also be referred to as the remote controller 3 hereafter.

As illustrated in FIG. 8, in the same manner as the first embodiment, the remote controller 3 includes a storage medium connector 81, a control unit 82, a memory 83, a radio wave transmitter-receiver 84, a power supply unit 85, an image signal processing unit 86, and a display unit 87. The memory card 5 is connectable to the storage medium connector 81.

The storage medium connector 81 can be configured by a card connector connected to the memory card 5, which is arranged at a predetermined location. The memory card 5 is a portable medium like that described in the first embodiment.

The control unit 82 is configured by one or more integrated circuits. The control unit 82 controls the operation of the remote controller 3 based on remote control programs stored in the memory 83.

The memory 83 is formed by a hard disk, a flash memory, or the like and stores programs related to the operation of the smartphone serving as the remote controller 3 and application programs such as the remote control application. The memory 83 also stores image data captured by a built-in camera (not illustrated) and various types of data obtained through e-mails and the Internet.

The radio wave transmitter-receiver 84 is a wireless module including an antenna. Further, the radio wave transmitter-receiver 84 functions as a signal transmitter that transmits, through wireless communication, signals that are receivable by the radio wave transmitter-receiver 34 of the projector body 2.

The power supply unit 85 is formed by a rechargeable battery, such as a lithium battery.

The image signal processing unit 86 performs an image signal process to generate image signals to show an image on the remote controller 3.

The display unit 87 includes a display 87a, which displays an image based on image signals processed by the image signal processing unit 86. As illustrated in FIG. 9, the remote controller 3 has an operation panel. Most of the upper part of the operation panel is occupied by the display 87a. When the remote control application is activated, the display 87a shows an image used for remote control operations.

Further, the remote controller 3 includes an operation unit 90 used to activate the remote control application and allow for remote control operations of the projector body 2. As illustrated in FIG. 9, basic operation keys 91, which are used to perform basic smartphone operations, are arranged under the display 87a. The basic operation keys 91 form part of the operation unit 90 in the second embodiment.

The operation keys 91, which are push-button type keys that form a man-to-machine interface, includes a home key 91a, a back key 91b, and a menu key 91c. The home key 91a is pressed to show every application on the display 87a. The back key 91b is pressed to return to the previous page. The menu key 91c is pressed to show a menu of options that can be used on the display 87a.

In the remote controller 3, when the remote control application is selected from the applications shown on the display 87a, a remote control operation screen is shown on the display 87a to perform a remote control operation with the projector body 2. For example, the remote control operation screen shows the image of the remote controller 3 such as that of the first embodiment.

As illustrated in FIG. 9, the remote control operation screen includes a power key 92, a standby key 93, a menu display key 94, a cancel key 95, a select key 96, pointer movement keys 97, an upload key 98, and a delete key 99. These keys are touch-type keys that form a man-machine interface and form the operation unit 90 with the basic operation keys 91.

The power key 92 corresponds to the switch 51 of the first embodiment. When the power key 92 is pressed, the projector body 2, which is not displaying an image, starts an image displaying operation.

The standby key 93 corresponds to the switch 52 of the first embodiment. When the standby key 93 is pressed, the projector body 2, which is displaying an image, stops an image displaying operation.

The menu display key 94 corresponds to the switch 53 of the first embodiment. When the menu display key 94 is operated, the projector body 2, which is displaying an image, displays a menu image. The menu image includes a list of functions, which can be implemented by the projector body 2, and a pointer, which is pointed at any one of the items shown in the list.

The cancel key 95 corresponds to the switch 54 of the first embodiment and is used to cancel the operation of the operation unit 50.

The select key 96 corresponds to the switch 55 of the first embodiment. The select key 96 is used to select the item pointed by the pointer in the menu image, which is displayed as an OSD image by the projector body 2.

The pointer movement keys 97 correspond to the switches 56 of the first embodiment and are used to move the pointer in the menu image.

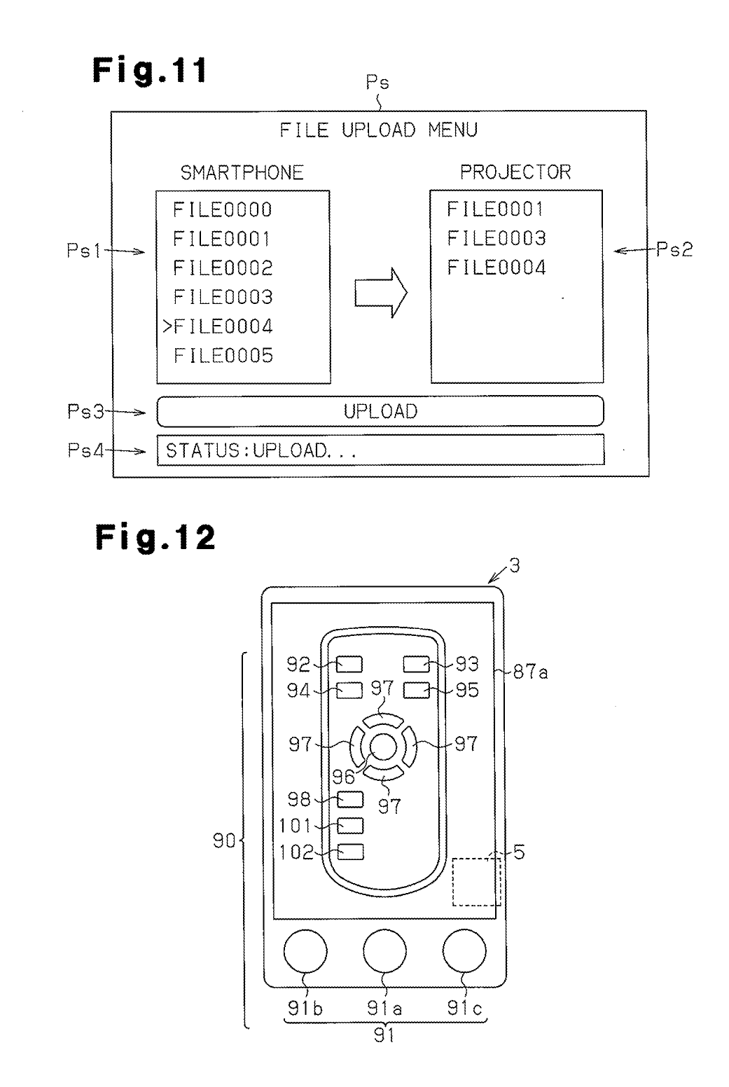

The upload key 98 is used to show a file upload menu Ps (refer to FIG. 11) on the display 87a of the remote controller 3. The delete key 99 is used to display the file delete menu Q (refer to FIG. 7) with the projector body 2.

In the same manner as the video projector 1 of the first embodiment, in addition to a function for receiving signals from the radio wave transmitter-receiver 84 with the radio wave transmitter-receiver 34, the projector body 2 has a received data storage function, a display data selection function, a stored data display function, a delete data selection function, a data deletion function, and an OSD function related to the operation menu. These functions are similar to those of the first embodiment and will not be described again. In the second embodiment, the display data selection operation unit for the display data selection function is formed by the select key 96, the pointer movement keys 97, and the upload key 98 of the operation unit 90. The keys 96, 97, and 98 respectively correspond to the switches 55, 56, and 57 of the first embodiment. Further, the delete data selection operation unit for the delete data selection function is formed by the select key 96, the pointer movement keys 97, and the delete key 99 of the operation unit 90. The keys 96, 97, and 99 respectively correspond to the switches 55, 56, and 58 of the first embodiment.

Further, in the same manner as the first embodiment, the remote controller 3 includes a transmission data selection function and a data transmission function in addition to the normal functions used for remote control operations of the projector body 2.

The transmission data selection function determines, from the data stored in the memory card 5 connected to the storage medium connector 81, the data that is to be transmitted through wireless communication from the radio wave transmitter-receiver 84. The data transmission function transmits the data stored in the memory card 5 connected to the storage medium connector 81 through wireless communication from the radio wave transmitter-receiver 84.

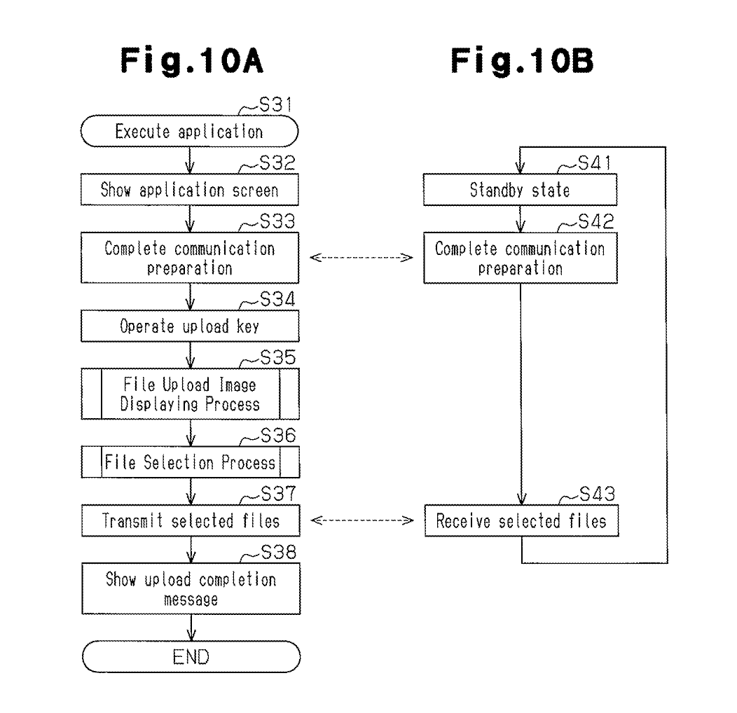

Data transmission of the remote controller 3 and data reception of the projector body 2, which differ from the first embodiment, will now be described with reference to FIGS. 10A, 10B, and 11.

When a user of the video projector 1 of the second embodiment performs data transmission, the user first presses the home key 91a on the operation panel of the remote controller 3 to activate the remote control application (step S31). This shows the remote control application screen (refer to FIG. 9) on the display (step S32). In the projector body 2, which is connected to a power cable, the radio wave transmitter-receiver 34 is active and in a standby state so that signals can be received through wireless communication from the remote controller 3 (step S41).

When the remote control application is activated, the radio wave transmitter-receiver 62 of the remote controller 3 is activated, and a communication channel is established with the radio wave transmitter-receiver 34 of the projector body 2 (steps S33 and S42). Then, the remote controller 3 transmits a signal for performing a remote control operation with the projector body 2 through wireless communication. Further, the remote controller 3 is in a state in which it can transmit the data stored in the memory card 5 to the projector body 2.

Then, when the user operates the upload key 98 of the remote controller 3 (step S34), a file upload menu display process is performed to select files that are transmitted to the projector body 2 (step S35). When the file upload menu display process is performed, a file upload menu Ps of FIG. 11 is shown on the display 87a. The contents of the file upload menu Ps are substantially the same as the file upload menu P displayed as an OSD image by the projector body 2. More specifically, the file upload menu Ps includes an image Psi of a list of the file names stored in the memory card 5, that is, a list of the data stored in the memory card 5. The file upload menu Ps also includes an image Ps2 of a list of file names that are to be uploaded, that is, a list of transmission data. Further, the file upload menu Ps includes an image Ps3 of an upload key used to transmit the selected data and an image Ps4 indicating a transmission status of the selected data.

In the second embodiment, the transmitted file data is selected from the file names shown in the data list of the image Ps1. A touch operation is performed to touch and select a file name of the data that is to be transmitted from the file names shown in the image Ps1. The transmission data selection function of the remote controller 3 in the second embodiment is performed in this manner. Further, a transmission data selection operation unit for the transmission data selection function is formed by the image Psi that allows for the selection of the files that are to be transmitted through touch operations.

The data files selected by touch operations on the image Ps1 is shown in the image Ps2 of the list of the selected data (step S36). Further, in the file upload menu Ps, the data files names in the image Ps2 are shown, for example, in a different color.

After the user completes the selection of the transmission data in step S36, the user touches the upload key in the image P3. This highlights the peripheral line of the image P3. Then, the control unit 82 transmits the files selected in step S36, that is, the selected transmission data, to the projector body 2 (step S37). The radio wave transmitter-receiver 62 receives the transmission data (step S43).

The image Ps4 shows the message of “UPLOAD” during the transmission of the data files and changes the message when the transmission is completed. For example, the message is changed to “COMPLETE” (step S38). This ends the date file transmission.

As described above, the data stored in the memory card 5 is transmitted from the remote controller 3 to the projector body 2. Then, the projector body 2 stores the received data in the memory 32.

The management of the data stored in the memory 32 will now be described.

In the same manner as the first embodiment, the video projector 1 displays a file selection image (not illustrated) with the projector body 2 to select the file of the image that is to be displayed. This allows the data of the image that is to be displayed to be selected from the data stored in the memory 32. Whenever the selected display is displayed, there is no need to transmit data through wireless communication from the remote controller 3. Thus, even when images are repetitively displayed, power is not consumed for wireless transmissions.

Further, in the same manner as the first embodiment, the video projector 1 can implement the delete data selection function and a data deletion function of the projector body 2 to determine the data that is to be deleted from the memory 32 and delete the determined data from the memory 32.

The data deletion operation will now be described. The user touches the delete key 99 in the remote control operation screen shown on the remote controller 3 when activating the remote control application. This displays the file delete menu Q illustrated in FIG. 7 with the projector body 2. The user operates the select key 96 and the pointer movement keys 97 of the operation unit 90 to select the file name of the data that the user wishes to delete. The user then touches the select key 96, and the selected file is displayed in the image Q2.

After all of the files that the user wishes to delete are displayed in the image Q2 by operating the select key 96 and the pointer movement keys 97, the user moves the pointer downward with the pointer movement keys 97 and selects the delete key shown in the image Q3. When touching the select key 96, the peripheral line of the image Q4 is highlighted, and the files that are to be deleted are deleted. The image Q4 shows the message of “DELETE” during the file deletion and shows the message of “COMPLETE” when the file deletion is completed.

In addition to the advantages (1) to (5) of the first embodiment, the video projector of the second embodiment has the advantages described below.

(6) The function for controlling the operation of the projector body 2 from a distance and the function for uploading the data stored in the memory card 5 (information storage medium) are concentrated in the remote controller 3. This improves convenience for the user. Further, a typical remote controller of the prior art can be used. Thus, when there is no need to upload the data stored in the information storage medium to the projector body 2, the typical remote controller can be used.

(7) When uploading the data stored in the information storage medium to the projector body 2, the user can perform operations while viewing the display 87a of the remote controller 3 that can be handheld. Thus, there is no need to view the distant image projected by the projector body 2. This improves the operability.

A video projector 1 according to third embodiment will now be described with reference to FIGS. 12 to 14.

The video projector 1 of the third embodiment is obtaining by changing the management of the data stored in the memory 32 of the projector body 2 in the second embodiment. The third embodiment will now be described centering on the difference from the second embodiment. Like or same reference numerals are given to those components that are the same as the corresponding components of the second embodiment. Such components will not be described in detail. In the description of the third embodiment, the remote controller 3 will refer to a smartphone.

A first change made to the second embodiment is in how the file display menu, which is used to select the file of the image that is to be displayed, is shown. In the second embodiment, the projector body 2 displays the file display menu as an OSD image. In the third embodiment, the file display menu is shown on the display 87a of the remote controller 3.

A second change made to the second embodiment is in how the file delete menu, which is used to select data that is to be deleted from the memory 32, is shown. In the second embodiment, the projector body 2 displays the file delete menu as an OSD image. In the third embodiment, the file delete menu is shown on the display 87a of the remote controller 3.

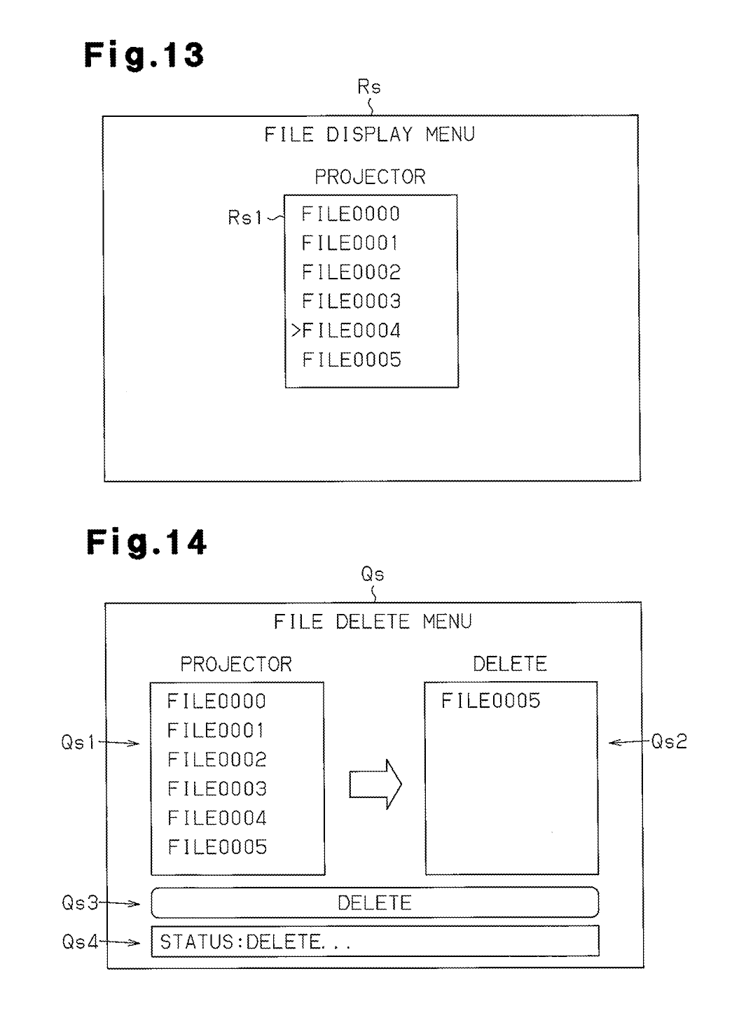

To realize these changes, as illustrated in FIG. 12, the remote control operation screen shown on the remote controller 3 of the third embodiment includes a display key 101 and a delete key 102. The display key 101 is used to show a file display menu Rs (refer to FIG. 13) on the display 87a. The delete key 102 is used to show a file delete menu Qs (refer to FIG. 14) on the display 87a. The delete key 102 is used in lieu of the delete key 99 of the second embodiment.

In the third embodiment, with regard to the first change, a display data selection function, which selects the data of the image that is to be displayed from the data stored in the memory 32, and a display function, which displays the selected data, are implemented in the following manner.

The user presses the home key 91a on the operation panel of the remote controller 3 to activate the remote control application. In this state, the user touches the display key 101. This downloads data file names from the memory 32 of the projector body 2 and shows the file display menu Rs, such as that illustrated in FIG. 13, on the display 87a of the remote controller 3. The remote control operation screen such as that illustrated in FIG. 12 may be switched to the file display menu Rs. Alternatively, the remote control operation screen and the file display menu Rs may be shown together on the same display 87a.

The file display menu Rs shows a list of the file names stored in the memory 32, that is, an image Rs1 of a list of the data stored in the memory 32.

Then, the user selects the desired file from the image Rs1 of the list of file names stored in the memory 32 and touches the file name. This transmits the selected file information to the projector body 2. The control unit 41 of the projector body 2 performs image processing on the selected file and shows the image of the file.

In the third embodiment, with regard to the second change, a delete data selection function, which selects data that is to be deleted from the memory 32, and a delete data selection function, which deletes the selected data, are implemented in the following manner.

The user presses the home key 91a on the operation panel of the remote controller 3 to activate the remote control application. In this state, the user touches the delete key 102. This downloads data file names from the memory 32 of the projector body 2 and shows the file delete menu Qs, such as that illustrated in FIG. 14, on the display 87a of the remote controller 3. The remote control operation screen such as that illustrated in FIG. 12 may be switched to the file delete menu Qs. Alternatively, the remote control operation screen and the file delete menu Qs may be shown together on the same display 87a.

The file delete menu Qs includes a list of the file names stored in the memory 32, that is, an image Qs1 of a list of the data stored in the memory 32. Further, the file delete menu Qs includes a list of the file names of the data that is to be deleted, that is, an image Qs2 of a list of the data selected as data to be deleted based on the image. The file delete menu Qs also includes an image Qs3 of a delete key used to delete the selected file and an image Qs4 indicating a data deletion status of the projector body 2.

After the file delete menu Qs is shown, the user selects a file that he or she wishes to delete and deletes the selected file in the following manner.

First, the user selects the desired file from the image Qs1 of the list of file names stored in the memory 32 and touches the file name. This shows the file name in the image Qs2. In this manner, the selected files that the user wishes to delete are all shown in the image Qs2.

Then, the user touches the image Qs3 of the delete key shown on the display 87a to delete the selected files. When the user performs this deletion operation, a list of the file names that are to be deleted is transmitted to the projector body 2, and the control unit 41 of the projector body 2 deletes the corresponding files from the memory 32. In this state, the peripheral line of the image Qs3 is highlighted to indicate that data is being deleted. Further, the image Qs4 shows the message of “DELETE” during the file deletion and changes the message to “COMPLETE” when the file deletion is completed.

In this manner, by showing the file delete menu Qs on the remote controller 3, the user can refer to the file delete image Qs to check the data stored in the memory 32, the data selected for deletion, and the data deletion status of the projector body 2.

In addition to advantages (1) to (5) of the first embodiment and advantages (6) and (7) of the second embodiment, the third embodiment has the advantages described below.

(8) When uploading the data stored in the memory card 5 to the projector body 2, displaying the image of a file stored in the memory 32 of the projector body 2, and deleting a file from the memory 32, the user can perform operations while viewing the display 87a of the remote controller 3 that can be handheld. Thus, there is no need to view the distant image projected by the projector body 2. This improves the operability.

(9) In the third embodiment, there is no need to display an OSD image with the projector body 2 to delete a file from the memory 32. Accordingly, the user can delete an unnecessary file while continuously projecting an image.

(10) The deletion of a file from the memory 32 does not require the projector body 2 to project an OSD image. Thus, the file deletion can be performed in a standby state in which the lamp of the projector body 2 is turned off. This reduces power consumption when a file is deleted.

It should be apparent to those skilled in the art that the present invention may be embodied in many other specific forms without departing from the spirit or scope of the invention. Particularly, it should be understood that the present invention may be embodied in the following forms.

In each of the above embodiments, the projector body 2 has a display data selection function. However, this function may be eliminated. In such a case, the projector body 2 can sequentially display the images of the files of data stored in the memory 32.

In each of the above embodiments, the projector body 2 has a delete data selection function. However, this function may be eliminated. In such a case, the projector body 3 may delete all of the files stored in the memory 32 with the data deletion function.

In each of the above embodiment, the remote controller 3 has a transmission data selection function. However, this function may be eliminated. In such a case, the remote controller 3 may transmit all of the data stored in the memory card 5 with the data transmission function.

In the first embodiment, the radio wave transmitter-receiver 34, which is a signal transmitter, of the remote controller 3 transmits data on radio waves. However, the data stored in the memory card 5 may be transmitted on infrared light. More specifically, a signal transmitter may be formed by the infrared transmitter 61, which transmits data with infrared light. In this case, a signal receiver of the projector body 2 may be formed by, for example, the infrared receiver 33.

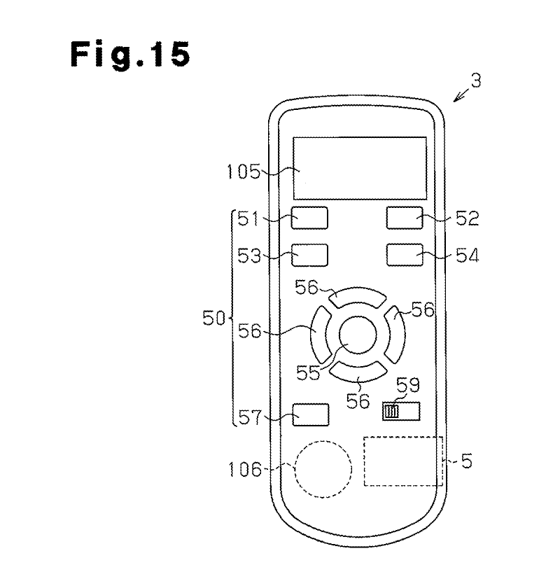

In the first embodiment, the projector body 2 displays the file upload menu P. However, as illustrated in FIG. 15, a display 105, which is formed by, for example, an LCD panel, may be arranged in the remote controller 3, and a file upload menu may be shown in the display 105. In this case, there is no need for the projector body 2 to project the file upload menu P as an OSD image.

In the first embodiment, the image including the upload completion message that indicates the completion of the file transmission is showed as the OSD image. However, as illustrated in FIG. 15, a notification unit 106 may be arranged in the remote controller 3. The notification unit 106 may be, for example, a speaker. In this structure, the notification unit 106 notifies the completion of the file transmission. Further, the display 105 illustrated in FIG. 15 may notifies the completion of the file transmission. In this case, the display 105 of the remote controller 3 serves as the notification unit.

In the first embodiment, the controller 71 controls to stop supplying power from the power supply unit 72 to the radio wave transmitter-receiver 62. However, as illustrated in FIG. 15, for example, a slide switch 59 that is operable by the user to supply power from the power supply unit 72 to the radio wave transmitter-receiver 62 may be arranged in the operation unit 50.

In each of the above embodiments, the projector body 2 includes the image signal input unit 21 and the operation unit 31. However, the image signal input unit 21 and the operation unit 31 may be omitted. Further, the projector body 2 may include a storage medium connector to which the memory card 5 is connectable.

In the first embodiment, the operation unit 50 is formed by a plurality of push button switches but may be formed by a man-machine interface other than the push button switches. For example, the operation unit 50 may be formed by a touch panel.

In each of the above embodiments, the image generation unit 12 is formed by dot matrix type liquid crystal light valves but may be formed by a digital micromirror device (DMD) including a matrix array of micromirrors. In this case, the DMD is driven by an image signal, and the DMD reflects the light from the light source 11. This generates an image based on the image signal.

In each of the above embodiments, the memory 32 is incorporated in the projector body 2. However, instead of being incorporated in the projector body 2, the memory 32 may be a memory that can be connected in a removable manner to the video projector 2 like a memory card. In this case, the removable memory may be an expansion memory. Further, when the projector body 2 can be reached by the user like when it is set on a table, such an external memory may be directly connected to the projector body 2 for use. In this manner, when the memory 32 can be connected in a removable manner, convenience is further improved.

In the second embodiment, the memory card 5 connected to the storage medium connector 81 may be used to store data that is received by the remote controller 3 from an external device.

In the second and third embodiments, a typical prior art remote controller can be used that transmits signals for activating and deactivating the projector body 2 and signals for setting the operation of the projector body 2. This may be modified so that only a smartphone can be used as the remote controller 3 to control the operation of the projector body from a distance.

In the second and third embodiments, when transmitting data from the remote controller 3, the file upload menu Ps is provided as the remote controller 3 on the display 87a of the smartphone. However, like in the first embodiment, the file upload menu Ps may be displayed as an OSD image by the projector body 2.

In the second and third embodiments, image data captured by a camera of the smartphone and data obtained through e-mails or the Internet may first be stored with their file names in the memory 83. Then, the data stored in the memory 83 may be transmitted from the radio wave transmitter-receiver 84 of the remote controller 3 to the projector body 2. This increases the additional value of the remote controller.

The present examples and embodiments are to be considered as illustrative and not restrictive, and the invention is not to be limited to the details given herein, but may be modified within the scope and equivalence of the appended claims.

1. A video projector comprising:
a projector body configured to project light to display an image and including a signal receiver and a memory which stores data; and
a remote controller configured to control the projector body from a distance and including a storage medium connector, to which an information storage medium is connectable in a removable manner, and a signal transmitter, which transmits a signal receivable by the signal receiver through wireless communication, wherein
the remote controller transmits the data stored in the information storage medium, which is connected to the storage medium connector, from the signal transmitter through wireless communication, and
the projector body stores the data received with the signal receiver in the memory and displays an image based on the data stored in the memory after the signal receiver completes receiving the data from the signal transmitter.

2. The video projector according to claim 1, wherein
the information recording medium includes a memory card, and
the signal transmitter transmits the data on a radio wave.

3. The video projector according to claim 1, wherein
at least one of the remote controller and the projector body includes a transmission data selection operation unit formed by a man-machine interface, and
the remote controller determines transmission data that is to be transmitted through wireless communication from the signal transmitter, from the data stored in the information storage medium, when the transmission data selection operation unit is operated.

4. The video projector according to claim 1, wherein
at least one of the remote controller and the projector body includes a delete data selection operation unit formed by a man-machine interface, and
the projector body determines data to be deleted from the data stored in the memory when the delete data selection operation unit is operated.

5. The video projector according to claim 1, wherein
the projector body displays an image of a file upload menu as an on-screen display image, and
the remote controller uploads data, which is in a file selected on the file upload menu, from the information storage medium to the projector body.

6. The video projector according to claim 5, wherein the projector body activates the signal receiver when receiving an upload signal from the remote controller.

7. The video projector according to claim 1, wherein
the remote controller includes a display that shows a file upload menu, and
the remote controller uploads data, which is in a file selected on the file upload menu, from the information storage medium to the projector body.

8. The video projector according to claim 7, wherein
the remote controller shows, on the display, a file display menu used to select display data from the data uploaded to the projector body, and
the projector body displays the data selected on the file display menu.

9. The video projector according to claim 7, wherein
the remote controller shows, on the display, a file delete menu used to select data to be deleted from the data uploaded to the projector body, and
the projector body displays the data selected on the file delete menu.

10. A method for displaying an image using a projector body, which projects light to display the image, and a remote controller, which controls the projector body from a distance, wherein the remote controller includes a storage medium connector, to which an information storage medium is connectable in a removable manner, and a signal transmitter, which transmits a signal receivable by the signal receiver through wireless communication, and the projector body includes a signal receiver, which receives the signal transmitted from the signal transmitter, and a memory, which stores data, the method comprising:
transmitting the data stored in the information storage medium, which is connected to the storage medium connector, from the signal transmitter through wireless communication;
storing the data received with the signal receiver in the memory; and
displaying an image based on the data stored in the memory after the signal receiver completes receiving the data from the signal transmitter.
